(19) United States
(12) Patent Application Publication
(10) Pub. No.: US 2004/0223648 A1
(43) Pub. Date: Nov. 11, 2004

(54) Determining differences between documents

(76) Inventors: Keith Hoene, Boise, ID (US); Robert Sesek, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/430,203

(22) Filed: May 5, 2003

(51) Int. Cl. G06K 9/32; G06K 9/68

(52) U.S. Cl. 382/218; 382/294

(57) ABSTRACT

A method for determining differences between a first document and a second document is provided, such method including scanning a first hard copy document with a multi-functional device to produce a first scanned document, automatically comparing the first scanned document with a second scanned document, and generating a document difference report based on the comparison of the first scanned document with the second scanned document.

### BACKGROUND

Although electronic documents are utilized in almost every industry today, hard copy documents (paper documents) still continue to be produced and circulated. Such hard copy documents remain a mainstay of today's culture. Hard copy documents may be copied using photocopiers or other copying devices. Sometimes it may be difficult to identify whether two or more hard copy documents are identical.

Comparing two or more hard copy documents manually is a time-consuming and tedious process. Typically, the hard copy documents are manually compared line-by-line and word-by-word. Such manual comparisons may not be very time efficient. Moreover, there is a high likelihood of human error in such manual comparisons. Comparing the hard copy documents in electronic format may involve the use of a scanner, an associated computer, optical character recognition (OCR) software, and document difference software.

Moreover, in some environments, the OCR scanner and the computer with the document difference program may be utilized by multiple users. A user may find it difficult to obtain access to both the OCR scanner and the computer when attempting to compare documents. Delays between scanning and comparing may be frustrating to a user and may result in time and resource inefficiencies.

### BRIEF DESCRIPTION OF THE DRAWINGS

FIG. 1 is a somewhat schematic illustration of a system for generating a document difference report for two hard copy documents using a multi-functional device according to an embodiment of the present invention.

FIG. 2 is a simplified block diagram of the multi-functional device shown in FIG. 1 according to an embodiment of the present invention.

FIG. 3 is a flow diagram of a method of generating a document difference report for two hard copy documents using a multi-functional device.

FIG. 4 is a schematic illustration of exemplary document difference reports generated by comparing a first hard copy document with a second hard copy document.

FIG. 5 is another schematic illustration of exemplary document difference reports generated by comparing a first hard copy document with a second hard copy document.

FIG. 6 is an exemplary illustration of a comparison options screen with user-selectable options for a multi-functional device.

FIG. 7 is an exemplary illustration of a document difference report options screen with user-selectable options for a multi-functional device.

### DETAILED DESCRIPTION

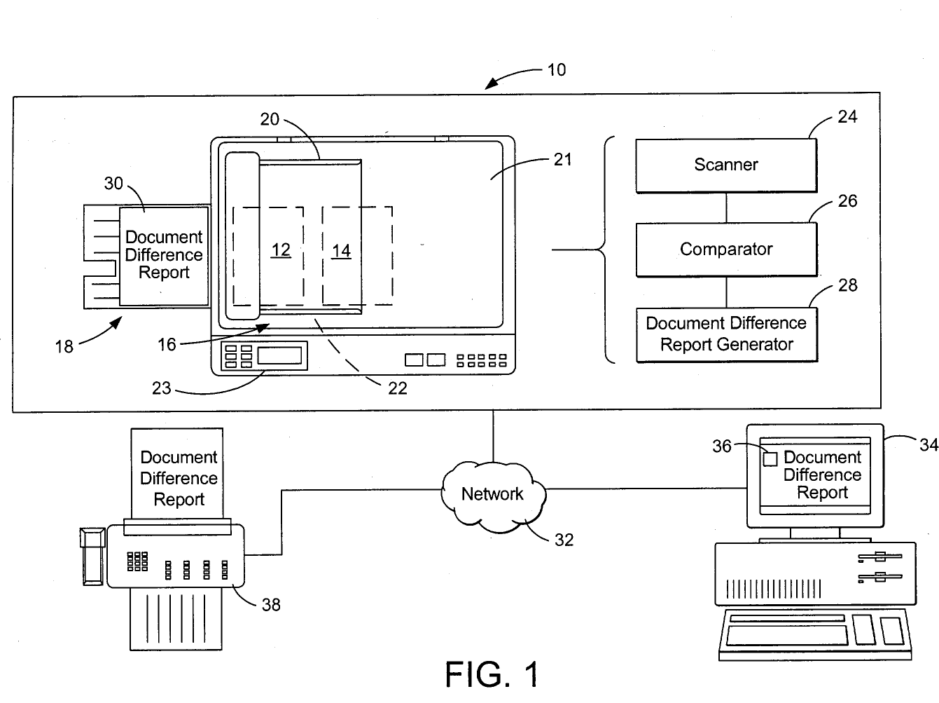

Referring initially to FIG. 1, a multi-functional device according to an embodiment of the present invention is shown generally at 10. Multi-functional device 10 may be adapted to scan a hard copy document, and may be adapted to produce one or more hard copy duplicate documents of the scanned original hard copy document. For example, multi-functional device 10 may be a stand-alone copier, such as a multi-functional copier, with the functions described herein.

In some embodiments, multi-functional device 10 may be linked to a network 32 such that the multi-functional device may, in addition to scanning and printing documents, transmit and receive electronic messages and files. Devices that are capable of scanning, copying, transmitting and receiving images are commercially available and are commonly referred to as “multi-functional”, “all-in-one”, or “printer-copier-fax” machines. It should be appreciated that multi-functional device, as used herein, includes both networked and non-networked devices. Further, it should be appreciated that multi-functional device 10 may be of any suitable size. For example, multi-functional device 10 may be a large stand-alone device or a desktop-sized device.

Multi-functional device 10 is configured to receive one or more hard copy documents 12, 14. As used herein, each hard copy document 12, 14 may be a single page document or a multi-page document. Further, it should be appreciated that each hard copy document 12, 14 may include text images and/or graphic images, such that each hard copy document may be a text-based document, a graphics-based document, a combination graphics and text-based document, etc. Graphic images may include charts, pictures, diagrams, watermarks, logos, and other non-text images. Although described herein as comparing a first hard copy document with a second hard copy document, it should be noted that more than two documents may be compared. Thus, multiple versions of a document may be compared using the systems, device and methods described herein. Moreover, in some embodiments, comparing a first hard copy document with a second hard copy document may involve a user selecting to compare only portions of such documents.

Multi-functional device 10 includes a media input area 16 and output area 18. Media input area 16 may be a portion of the multi-functional device, such as the top of the scanner glass, or may be a feeder, such as an automatic document feeder (ADF) 20. Where two single-page hard copy documents are to be compared, such as hard copy documents 12, 14, the single-page hard copy documents may be aligned on scanner glass 22, under cover 21, such that both hard copy documents are accommodated on the scanner glass at the same time. In such a configuration, both hard copy documents may be recognized as discrete documents and may be scanned in a single pass by scanner 24 (described below).

In other embodiments, each hard copy document may be consecutively scanned. For example, the multi-functional device may include an input tray or automatic feeder, such as ADF 20, which may allow a user to insert multiple hard copy documents into the device for scanning or copying. The multi-functional device typically scans each sheet of a multi-page hard copy document consecutively and outputs the sheets in an ordered pile after scanning. For example, a first multi-page hard copy document may be input into ADF 20, scanned and stored in memory on multi-functional device 10. Following, the scan of the first multi-page hard copy document, a second multi-page hard copy document may be input into multi-functional device 10 via ADF 20, scanned and stored in memory on multi-functional device 10. Single-page hard copy documents similarly may be scanned and stored in memory on multi-functional device 10 via ADF 20. As described in more detail below, after scanning both hard copy documents, the two scanned and stored hard copy documents may be compared.

It further should be noted that some multi-functional devices may be equipped to handle two-sided hard copy documents. For example, many commercial, multi-functional copiers have the ability to scan and print on double-sided media. Such functionality may allow the multi-functional device to be used to compare double-sided hard copy documents.

In some embodiments, it should be appreciated that a hard copy document may be compared to an electronic copy of a document previously scanned and stored on the device or accessible to the device. For example, a user may scan one or more hard copy documents and direct the device to compare the hard copy documents to a user-selected electronic copy of a document previously scanned and saved on the device or on the network linked to the device. Thus, although the following discussion describes comparing two or more hard copy documents, it should be understood that the need not necessarily be scanned close in time, or even using the same scanning device.

Multi-functional device 10 further may include a control panel 23 configured to enable a user to select a desired operation or function of the device. Control panel 23 may include a series of user input devices, e.g. buttons, which allow the user to select a desired function, such as performing a hard copy document comparison. As described in more detail below, control panel 23 further may enable a user to select various options related to performing the hard copy document comparison.

Multi-functional device 10 typically includes a scanner 24 configured to enable multi-functional device 10 to scan two or more hard copy documents 12, 14 into multi-functional device 10 to create at least a first scanned hard copy document and a second scanned hard copy document. Typically, scanner 24 is integrated into multi-functional device 10. Coupled with, or incorporated within, scanner 24 is comparator 26 configured to compare the scanned documents. Moreover, although depicted where comparator 26 is localized on the multi-functional device, comparator 26 may be remote (not shown), such that it is linked to the multi-functional device via a network (e.g. network 32). However, comparator 26 typically is controllable through multi-functional device 10, and thus scanner 24.

In some embodiments, scanner 24 and comparator 26 utilize optical character recognition (OCR) or other suitable software to scan and compare text differences between the first and second scanned hard copy document. OCR typically involves the recognition of printed or written text characters. Recognition of printed or written text characters via OCR may involve photoscanning of the text character-by-character, analyzing the scanned image, and then translating the written text character images into character codes, such as American Standard Code for Information Interchange (ASCII), which is commonly used in data processing. Typically, in OCR processing, the scanned text image is analyzed for light and dark areas to identify each alphabetic letter or numeric digit. Although described in relation to OCR processing, it should be appreciated that other suitable scanners and comparators using different software, firmware, etc. may be used in the present device, system and/or methods.

For example, comparator 26 may compare text and/or graphic images on a first and second scanned hard copy document using a user-selectable or default dialed-in percentage. Thus, a user may select the degree to which a graphic image in a first document is compared to a graphic image in a second document.

Comparator 26 may include or be linked to a document difference report generator 28. Document difference report generator 28 generates a document difference report containing the differences between the first and second hard copy documents. Thus, the document difference report typically is based on the comparison of the first and second scanned hard copy documents.

The document difference report may be output in hard copy form or in electronic form to a variety of devices. For example, the document difference report may be output to a printer integrated within multi-functional device 10 to produce a hard copy document difference report 30. Thus, the user may use a single device to scan and compare two or more hard copy documents. The user further may use the same device to print a report of the results of the comparison of the hard copy documents.

In other embodiments, the document difference report may be output as an electronic document. For example, the document difference report may be sent to a network device via network 32. Network 32 may be a local area network (LAN) or a public network, such as the Internet. Thus, a user may send the document difference report to a remote network device using a user-selected folder or via an electronic address. A user may access the electronic document difference report via a personal computer 34 or other suitable device that is linked to network 32. For example, the document difference report may be accessible via the user's electronic mail, as schematically indicated at 36.

The document difference report may be forwarded to other devices on the network. For example, the document difference report may be forwarded to a remote facsimile machine 38, network printer (not shown), or copy device (not shown), etc.

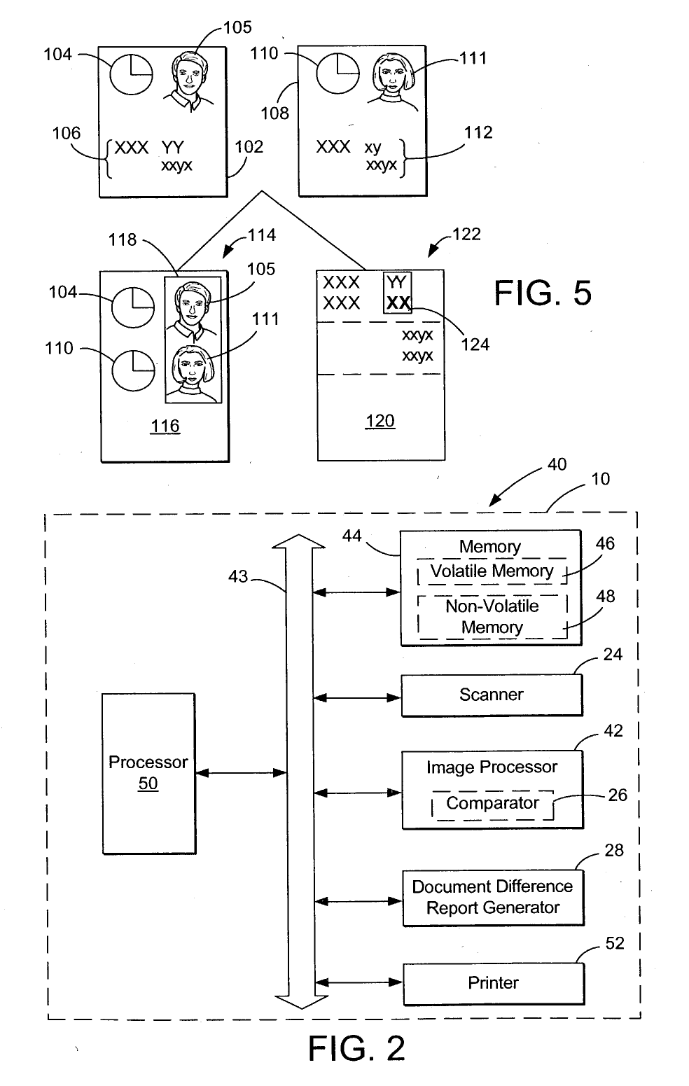

FIG. 2 shows generally, at 40, an exemplary, simplified block diagram of multi-functional device 10. Typically, and as described above, multi-functional device 10 includes a scanner 24 for reading hard copy documents. Scanner 24 may be coupled (via a bus 43) with an image processor 42 for processing the scanned documents. Scanner 24 and/or image processor 42 further may include comparator 26, including OCR software, firmware and/or hardware, as well as other types of character, design or pattern recognition software, firmware and/or hardware.

Scanner 24, image processor 42, document difference report generator 28, and/or printer 52 may be linked via bus 43 to memory 44, which may include both volatile memory 46 and non-volatile memory 48. Non-volatile memory 48 may be utilized for such functions as storing device software, fonts and other permanent or semi-permanent data. Any suitable type of non-volatile memory, including, but not limited to, ROM, PROM, EPROM, EEPROM and Flash memory, and combinations thereof, may be used for non-volatile memory 48.

Volatile memory 46 may be configured to store the scanned copies of the hard copy documents. Volatile memory 46 also may be configured to store user instructions regarding comparison of the hard copy documents and generation of a document difference report. Volatile memory 46 may include one or more suitable types of volatile memory, such as SRAM or DRAM. Multi-functional device 10 further may include a processor 50. Processor 50 may be linked via bus 43 to memory 44, scanner 24, image processor 42, document difference report generator 28, printer 52, etc.

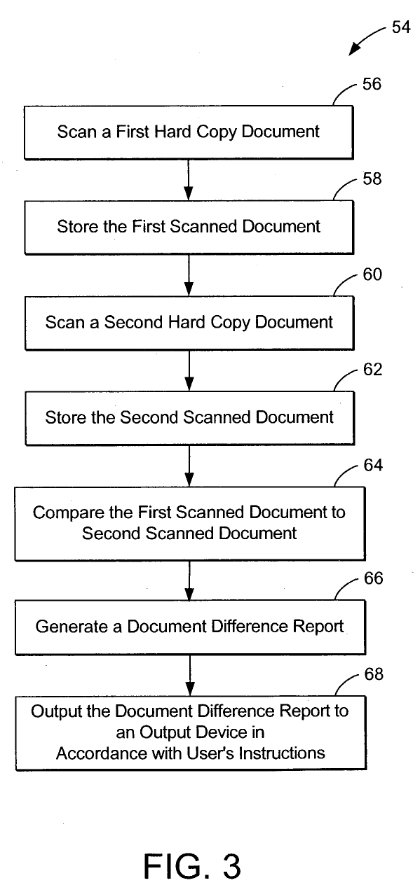

FIG. 3 shows, generally at 54, a method of comparing two hard copy documents in accordance with an embodiment of the present invention. As depicted, at 56, a first hard copy document may be scanned into the multi-functional device via scanner 24 shown in FIGS. 1 and 2. The first scanned document may then be stored, as shown at 58. Thereafter, a second hard copy document may be scanned (at 60) and stored (at 62). Both hard copy documents may be temporarily stored in memory 44 as shown in FIG. 2.

Referring still to FIG. 3, the first scanned document automatically may be compared to the second scanned document, as indicated at 64. The user does not need to retrieve the scanned documents using a separate personal computer, nor does the user need to run a document difference program from a separate computer on the scanned documents to compare the documents. In some embodiments, such as the embodiment illustrated in FIG. 2, image processor 42, and specifically comparator 26, may be used to compare the first and second scanned documents stored in memory 44. It should be appreciated that comparison 64 may be accomplished using any suitable comparison method After comparison, document difference report generator 28 may generate a document difference report, at 66, and output the document difference report to an output device in accordance with a user's instructions, as shown at 68. For example, a user may select the document difference report to be output to the printer integrated within multi-functional device 10. Thus, the document difference report may be generated and output to printer 52, shown in FIG. 2. Alternatively, or additionally, a user may select to have the document difference report output to one or more selected network device.

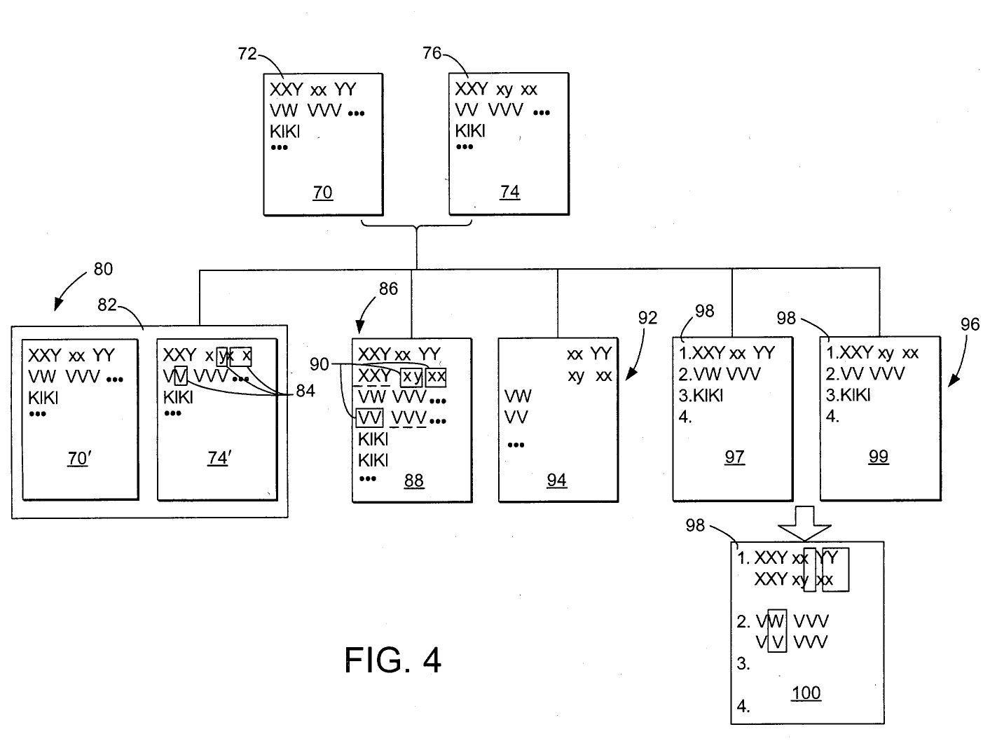

FIG. 4 illustrates a plurality of exemplary document difference reports. As shown, a user may desire to compare a first hard copy document 70 with text 72 to a second hard copy document 74 with text 76. Comparison of first hard copy document 70 with second hard copy document 74 may result in generation of a document difference report (also referred to herein as a difference document). In some embodiments, multiple user-selectable formats may be provided for the document difference report. A user may select the format of the document difference report based on the length of the hard copy documents, the type of hard copy documents, the estimated number of differences in the hard copy documents, user preference, etc. Variations between the hard copy documents may be indicated on the document difference report using various types of annotations, including highlighting, font changes, underlining, color-changes, italicizing, bolding, etc.

For example, a user may select to have each corresponding page of the first and second hard copy documents output on the same document difference report together. Thus, a first page of a first hard copy document may be printed on the same sheet as a first page of a second hard copy document. Similarly, a second page of the first hard copy document may be printed on the same sheet as a second page of the second hard copy document. By displaying copies of each page of both hard copy documents beside each other, a user may be able to quickly identify the differences between each page of the first and second hard copy documents.

For example, as shown at 80, a first page of document 70′ is printed beside a first page of document 74′ on a sheet 82. In some embodiments, the first document (shown as document 70′) may be selected as the master document. Additional documents, referred to herein as target documents, (such as document 74′), may be compared to the master document. By selecting a master document, multiple versions of the document may be more easily compared. The differences between the master document and the target documents may be annotated (as indicated at 84) on the respective target document, thus indicating portions of the target document that are not identical to the master document. For example, in the depicted illustration, the second phrase “xy” of line 1 in target document 74′ is different than the second phrase “xx” of line 1 in master document 70′. By annotating the difference between the master and target document, a user may quickly identify variations between the two documents. It should be noted that in some embodiments a user may select to generate a report with differences annotated on only one of the target document or master document. For example, the document difference report may include only target document 74′ with annotations indicating differences from the master document.

At 86, another exemplary document difference report 88 is illustrated. In document difference report 88, the two hard copy documents are interlaced. Specifically, in the depicted document difference report 88, each line of the first document is followed by the corresponding line of the other document. For example, in original hard copy document 70, the first line includes the following phrases “XXY xx YY” which is followed in document difference report 88 by the first line in original hard copy document 74, “XXY xy xx.” By generating an output where the first line of the second hard copy document 74 (target) is beneath the first line of the first hard copy document 70 (master), the differences in the two documents may be immediately evident. Further indication of the difference between the two lines may be used. For example, differences may be annotated, as shown at 90, or otherwise marked, e.g. underlined, bolded, italicized, different color, etc.

It should be noted that annotations also may be used in the document difference program to identify format differences, such as font size, font type, etc. between the hard copy documents. For example, a user may select a comparison that includes checking for case changes between the hard copy documents. In the present illustration, a document difference report may include an annotation (not shown) indicating case difference between the third phrase of line 1 (“YY”) of master document 70 and the third phrase of line 1 (“xx”) of target document 74.

At 92, another exemplary document difference report 94 is illustrated. Document difference report 94 includes another line-by-line comparison, where identical text between the original hard copy documents is left out of document difference report 94. Thus, only the differences between the original hard copy documents are output. In some embodiments, the identical text may be grayed-out or otherwise marked to identify identical text. For example, in some embodiments, the identical text may be in a first color, while non-identical text may be in a second color. The comparison may be line-by-line, as shown, or may be phrase-by-phrase, character-by-character, field-by-field, etc.

At 96, both the first hard copy document and second hard copy document may be reformatted 97, 99, respectively, with line numbers 98 or other indicators identifying comparable portions of the documents, such as paragraphs, sections or clauses. Line numbers 98 then may be used within the document difference report 100 to reference any differences in the selected portion of the first and second hard copy documents.

For example, in document difference report 100, line numbers 98 are used to indicate the corresponding lines in documents 97 and 99. As illustrated, differences in lines 1 and 2 result in the output (document difference report 100) including annotations showing the variations between lines 1 and 2 from documents 70 and 74. The lack of differences between line 3 of document 70 and line 3 of document 74 may be indicated by the absence of content in line 3 of difference report 100. Alternatively, other methods may be used to indicate that line 3 of document 70 is identical to line 3 of document 74.

FIG. 5 further illustrates an exemplary document difference report, which may be produced if graphic images are included in the first and second hard copy documents. Specifically, first hard copy document 102 may include graphic images 104, 105 in addition to text 106. Similarly, second hard copy document 108 may include graphic images 110, 111 and text 112. In comparing the first and second hard copy documents, both the text and the graphics may be compared. In some embodiments, a single document difference report may be generated including information regarding the differences between both the text and the graphic images. In other embodiments, separate difference reports may be generated, one for the text, and one for the graphic images. A user may be able to select whether a document difference report should be run for only the text, only the graphic images, portions of the text and/or graphic images, or both the text and the graphic images. It should be noted that the text and graphic images may be distinguished from each other as known in the art. The user may be able to further select the format of the document difference report or reports.

Specifically, FIG. 5 illustrates, at 114, a document difference report 116 reporting the differences in the graphic images of hard copy documents 102 and 108. Graphic images may include any non-text image, including pictures, photographs, charts, graphs, icons, watermarks, etc. As illustrated, graphic image document difference report 116 may include graphic images 104,105 from hard copy document 102 and graphic images 110, 111 from hard copy document 108. Graphic image document difference report 116 further may include annotations or indicators 118 indicating differences in graphic images 110, 111 in comparison to graphic images 104, 105. For example, box 118 indicates a difference in graphic image 105 and graphic image 111. It should be appreciated that other formats may be used to illustrate the difference between the graphic images on two or more hard copy documents.

A text-based document difference report 120 is shown generally at 122. As described above in relation to FIG. 4, the text-based document difference report may be in any suitable format, which indicates the text differences between document 102 and document 108. For example, the different text in document 108 may be indicated by using a different font or by highlighting and/or bolding the text, as indicated at 124.

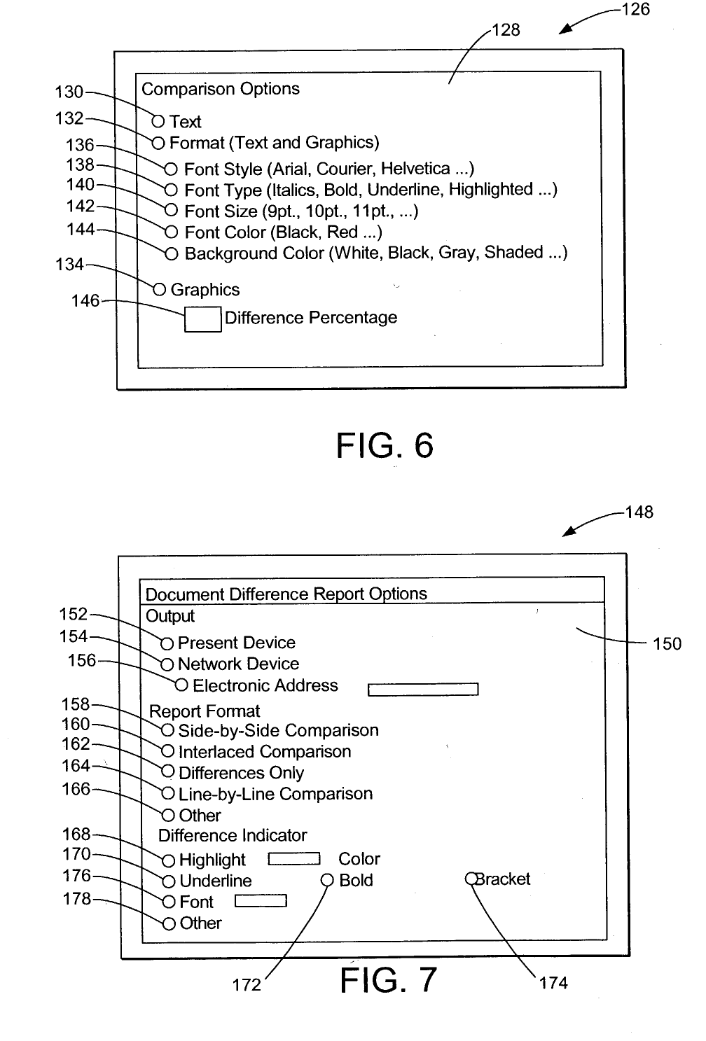

FIG. 6 illustrates, at 126, user-selectable options for comparing at least a first and second hard copy document. The user-selectable options may enable a user to control the type of comparison performed between two or more hard copy documents. For example, multi-functional device 10 may include a control panel configured to provide a comparison options display or screen 128. Comparison options display may be adapted to enable a user to easily select various options for comparing two or more hard copy documents. For example, a user may select to compare the text of two or more documents (at 130), the format of the text and graphics of two or more documents (at 132), or the graphics of two or more documents (at 134). A user who wishes to compare the format of the text and graphics also may select to compare different features of the documents, including the font style at (136), the font type (at 138), the font size (at 140), the font color (at 142), the background color (at 144), etc. A user further may select the percentage of fineness to compare graphics, as indicated (at 146).

FIG. 7 illustrates, at 148, various options for the format of the output, which results from comparing the first and second hard copy documents. For example, a control panel on multi-functional device 10 may include a document difference report options display or screen 150 that includes user-selectable preferences for the document difference report. On the exemplary display, a user may select to output the document difference report to one or more devices, such as the local multi-functional device (present device), at 152, or to another network device, indicated at 154. Other network devices may include network printers, network computers, facsimile machines, etc. The user may direct the document difference report to such other network device by inputting an electronic address at 156.

Still referring to FIG. 7, the user further may select options relating to the format of the document difference report. For example, the user may select to have the document difference report produced using a side-by-side comparison 158, an example of which is illustrated in FIG. 4 at 80. Alternatively, a user may select an interlaced comparison at 160 (an example of such an interlaced document difference report is illustrated in FIG. 4 at 86), a difference-only format at 162 (an example of such a difference-only document difference report is illustrated in FIG. 4 at 92), or a line-by-line comparison at 164 (an example of such a line-by-line comparison is illustrated in FIG. 4 at 96). As described above, it should be appreciated that other formats for the document difference report may be selected. For example, a user may select a user-defined document difference report or other previously formatted document difference report, as indicated at 166.

The user further may select options for the annotations used in the document difference report to indicate differences between text and/or graphic images in the first and second hard copy documents. For example, the user may select to highlight differences (at 168) between the text and/or graphic images. Depending on the output device, the user further may select various colors to highlight the different text or graphic images. Alternatively, a user may select indicators, such as underlining (at 170), bolding (at 172), or bracketing (at 174) to delineate differences in text and/or graphic images. In some embodiments, the user may be able to change the font of the identical text versus the font of the different text, as indicated at 176. Other options, at 178, for indicating text or graphic differences between two or more hard copy documents may be available or defined by the user.

It should be appreciated that in some embodiments, a user may opt to use preset defaults. For example, a user may use the preset defaults for comparing the first and second hard copy documents or for the output that results from comparing the first and second hard copy documents. An administrator, a prior user or manufacturer may determine which options are included in the preset defaults. In some embodiments, the settings for comparison or for the document difference report may be saved as a group or user profile. A user may access the group or user profile by entering a preset pin or code.

While the present description has been provided with reference to the foregoing embodiments, those skilled in the art will understand that many variations may be made therein without departing from the spirit and scope defined in the following claims. The description should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element or the equivalent thereof, such claims should be understood to include incorporation of one or more such elements, neither requiring, nor excluding, two or more such elements.

What is claimed is:

1. A method for determining differences between a first document and a second document, the method comprising:
scanning a first hard copy document with a multi-functional device to produce a first scanned document;
automatically comparing the first scanned document with a second scanned document; and
generating a document difference report based on the comparison of the first scanned document with the second scanned document.

2. The method of claim 1, wherein automatically comparing the first scanned document with the second scanned document includes comparing one or more of text, graphic images or format of the first scanned document with the second scanned document.

3. The method of claim 1, wherein generating a document difference report includes generating a side-by-side comparison of the first scanned document and the second scanned document.

4. The method of claim 1, wherein generating a document difference report includes generating a line-by-line comparison of the first scanned document and the second scanned document.

5. The method of claim 1, wherein generating a document difference report includes generating a document difference report including only the differences in the first scanned document and the second scanned document.

6. The method of claim 1, further comprising outputting the document difference report according to user instructions.

7. The method of claim 6, wherein outputting the document difference report includes printing the document difference report using the multi-functional device.

8. The method of claim 6, wherein outputting the document difference report includes sending the document difference report to a user-selected electronic address.

9. The method of claim 6, wherein outputting the document difference report includes sending the document difference report to a networked device.

10. The method of claim 9, wherein outputting the document difference report includes faxing the document difference report to a networked facsimile machine.

11. The method of claim 1, further comprising, prior to comparing the first scanned document with the second scanned document, receiving user direction regarding the type of comparison to perform.

12. The method of claim 11, wherein receiving user direction includes one or more of receiving a request to compare text of the first scanned document with text of the second scanned document, receiving a request to compare a graphic image of the first scanned document with a graphic image of the second scanned document, or receiving a request to compare a portion of the first scanned document with a portion of the second scanned document.

13. The method of claim 11, wherein receiving user direction includes receiving a request to compare format of the first scanned document with format of the second scanned document.

14. A system for determining differences between a target document and a master document, the system comprising:
a scanner configured to scan a target document to produce a scanned target document;
a comparator controllable from the scanner, the comparator configured to compare the scanned target document with a scanned master document;
a document difference report generator configured to generate a document difference report based on the comparison of the scanned target document with the scanned master document; and
an output device configured to output the document difference report.

15. The system of claim 14, wherein the scanner and the output device define a multi-functional device.

16. The system of claim 14, wherein the scanned master document is produced by scanning a first hard copy document with the scanner and storing the scanned first hard copy document as the master document.

17. The system of claim 15, further comprising a network, wherein the multi-functional device and the output device are linked to the network.

18. The system of claim 17, wherein the output device is a printer on the network.

19. The system of claim 17, wherein the output device is a computer on the network.

20. The system of claim 15, wherein the comparator is stored within the multi-functional device.

21. The system of claim 15, wherein the document difference report generator is stored within the multi-functional device.

22. The system of claim 15, wherein the comparator is accessible via a network linked to the multi-functional device.

23. The system of claim 15, wherein the document difference report generator is accessible via a network linked to the multi-functional device.

24. The system of claim 14, wherein the document difference report generator is configured to generate the document difference report based on user input.

25. The system of claim 14, wherein the document difference report includes a side-by-side presentation of the scanned target document and the scanned master document.

26. The system of claim 14, wherein the document difference report includes a line-by-line presentation of the scanned target document and the scanned master document.

27. The system of claim 14, wherein the document difference report includes a presentation with annotations emphasizing the differences in the scanned target document and the scanned master document.

28. The system of claim 14, wherein the document difference report includes only the differences in the scanned target document and the scanned master document.

29. The system of claim 14, wherein the comparator compares the scanned target document to the scanned master document according to user-selectable options.

30. The system of claim 29, wherein the user-selectable options include one or more of the following options: an option to compare text of the scanned target document and text of the scanned master document, an option to compare graphic images of the scanned target document and graphic images of the scanned master document, and an option to compare format of the scanned target document with format of the scanned master document.

31. A multi-functional device configured to determine differences between a first hard copy document and a second hard copy document, the multi-functional device comprising:
a scanner to scan a first hard copy document and a second hard copy document to produce a first scanned document and second scanned document respectively;
a comparator configured to compare the first scanned document with the second scanned document; and
a document difference report generator configured to generate a document difference report based on the comparison of the first scanned document with the second scanned document.

32. The device of claim 31, further comprising a printer configured to print the document difference report.

33. The device of claim 31, wherein the comparator automatically compares the first scanned hard copy document with the second scanned document according to user-selectable options.

34. The device of claim 33, wherein the user-selectable options include one or more of the following options: an option to compare text of the first scanned document and text of the second scanned document, an option to compare graphic images of the first scanned document and graphic images of the second scanned document, and an option to compare format of the first scanned document with format of the second scanned document.

35. The device of claim 31, wherein the document difference report generator is configured to generate the document difference report based on user input.

36. The device of claim 31, wherein the document difference report includes a side-by-side presentation of the first scanned document and the second scanned document.

37. The device of claim 31, wherein the document difference report includes a line-by-line presentation of the first scanned document and the second scanned document.

38. The device of claim 31, wherein the document difference report includes a presentation with annotations emphasizing the differences in the first scanned document and the second scanned document.

39. The device of claim 31, wherein the document difference report includes only the differences in the first scanned document and the second scanned document.

40. A multi-functional device configured to determine differences between a first hard copy document and a second hard copy document; the multi-functional device comprising:
means for scanning a first hard copy document and a second hard copy document to produce a first scanned document and a second scanned document;
means for comparing the first scanned document with the second scanned document; and
means for generating a document difference report based on the comparison of the first scanned document with the second scanned document.

41. A program storage device readable by a machine, the storage device tangibly embodying a program of instructions executable by the machine to perform a method for determining differences between a first document and a second document, the method comprising:
scanning a first hard copy document to produce a first scanned document;
storing the first scanned document;
comparing the first scanned document with a second scanned document; and
generating a document difference report based on the comparison of the first scanned document with the second scanned document.
